(19) United States
(12) Patent Application Publication
(10) Pub. No.: US 2007/0097037 A1
(43) Pub. Date: May 3, 2007

(54) ACTIVE MATRIX-TYPE DISPLAY APPARATUS AND CAMERA

(75) Inventors: Takanori Yamashita, Yokohama-shi (JP); Somei Kawasaki, Saitama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/552,233

(22) Filed: Oct. 24, 2006

(30) Foreign Application Priority Data
Oct. 27, 2005 (JP) 312786/2005

(51) Int. Cl. G09G 3/30

(52) U.S. Cl. 345/76

(57) ABSTRACT

An active matrix-type display apparatus, includes a plurality of pixels 101, each comprising a display device and an active element, arranged two-dimensionally; a plurality of data signal lines 102 extending in a direction; and a plurality of power lines 103 extending in a direction perpendicular to the data signal lines. The power lines 103 have a line width, at intersections of the data signal lines 102 and the power lines 103, smaller than that at a position other than the intersections. Alternatively, at the intersections, each of the power line 103 is branched into a plurality of power lines 103 so that a sum of line widths of the branched power line power lines 103 is smaller than a line width of the power lines 103 at the position other than the intersections.

### FIELD OF THE INVENTION AND RELATED ART

The present invention relates to an active matrix-type display apparatus and a camera, particularly in which a plurality of pixels which including a display device and an active element and are two-dimensionally arranged, a plurality of data signal lines is extended in one direction, and a plurality of power lines is extended in a direction perpendicular to the data signal lines.

In recent years, an electroluminescence (EL) device has been applied to an image display panel as an image display device (hereinafter, such an image display panel is referred to as an “EL panel”).

The EL device is a current drive-type device, so that a luminescence control method thereof includes a voltage setting method and a current setting method.

Japanese Laid-Open Patent Application (JP-A) 2003-228299 discloses a constitution of a pixel circuit using the voltage setting method. The constitution is shown in FIG. 10.

Referring to FIG. 10, voltage data V (data) are inputted into a drain of a transistor M1 via a data signal line 102. A drain of a transistor M3 is connected to a current injection terminal of an EL device. Further, a control signal is inputted into a gate of the transistor M1 via a row control line 104 and a gate of the transistor M3 via a row control line 105. A capacitor C1 has one terminal connected to a power source (Vcc) and the other terminal connected to a gate of the transistor M2 and a source of the transistor M1. A source of the transistor 2 is connected to the power source (Vcc), and a drain of the transistor 2 is connected to a source of the transistor M3. The transistor M3 is provided so as not to instantaneously pass an excessively large current through the EL device. In the case of effecting a dot sequential operation, there is no need to use the transistor M3. Further, in FIG. 2 of JP-A 2003-228299, a planar structure in which a plurality of data lines disposed along an array of organic EL devices from a signal line drive circuit and a plurality of power lines disposed in a column direction with a certain line width intersect each other is shown.

Next, a constitution of a pixel circuit using the current setting method described in U.S. Pat. No. 6,373,454 is shown in FIG. 11.

Referring to FIG. 11, current data I (data) are inputted into a source of a transistor M3 via a data signal line 102. A gate of a transistor M3 and a gate of transistor M4 are connected to a common control line 105. A source of the transistor M4 is connected with a drain of a transistor M3, a drain of a transistor M2, and a drain of a transistor M11. A drain of the transistor M4 is connected to a current injection terminal of an EL device. Further, a gate of the transistor M4 is connected to a capacitor C1 connected to a power line 103 at one end and connected to a source of the transistor M2 at the other end. A gate of the transistor M2 is connected to a control line 104, and a source of the transistor M1 is connected to the power line 103.

JP-A Hei 5-061069 has proposed a liquid crystal display apparatus in which at least one of widths of gate interconnecting lines and source interconnecting lines is made smaller than that at a portion other than intersections of these gate and source interconnecting lines in order to decrease a capacitance at intersections between the gate interconnecting lines and the source interconnecting lines (FIG. 2 etc.).

JP-A 2004-206055 has disclosed a method of decreasing parasitic capacitance of signal lines disposed in parallel to power lines in an organic EL display. The power lines are connected together to one broad common power wiring outside a display area, so that the signal lines intersect with the broad common power wiring outside the display area to produce the parasitic capacitor. In this method, the parasitic capacitance is decreased by providing a narrowed portion at the intersections between the common power wiring and the signal lines.

However, most of the conventional EL panels have such a structure that a plurality of signal lines (data lines) for supplying a data signal to a selected pixel and a plurality of power lines (Vdd) extending perpendicularly to the data lines intersect with each other in the display area. In this case, at intersections of the data lines and the power lines, parasitic capacitance is generated. As a result, an accurate data signal cannot be sufficiently written in a selected pixel circuit to impair a display quality.

### SUMMARY OF THE INVENTION

An object of the present invention is to solve the above described problem.

A specific object of the present invention is to provide a display apparatus capable of stably inputting an accurate signal in a selected pixel by decreasing a parasitic capacitance generated at intersections of data lines and power lines at a pixel circuit portion of an EL panel, thus improving a display quality.

According to an aspect of the present invention, there is provided an active matrix-type display apparatus, comprising:

a plurality of pixels, each comprising a display device and an active element, arranged two-dimensionally;

a plurality of data signal lines extending in one direction; and

a plurality of power lines extending in a direction perpendicular to the data signal lines;

wherein the power lines have a line width, at intersections of the data signal lines and the power lines, smaller than that at a position other than the intersections.

According to another aspect of the present invention, there is provided an active matrix-type display apparatus, comprising:

a plurality of pixels, each comprising a display device and an active element, arranged two-dimensionally;

a plurality of data signal lines extending in a direction; and

a plurality of power lines extending in a direction perpendicular to the data signal lines;

wherein each of the power lines is branched into a plurality of power lines at intersections of the data signal lines and the power lines, so that a sum of line widths of the branched power line power lines is smaller than a line width of the power lines at a position other than the intersections.

According to the present invention, it is possible to stabilize a writing operation of an image into a pixel circuit portion by suppressing an influence of a parasitic capacitance of the power lines and the data lines to ensure reliability of a power source.

The present invention is applicable to a digital still camera, a digital video camera, a PDA, a mobile phone, a television set and the like, using the active matrix display apparatus such as an EL display apparatus or a liquid crystal display apparatus.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a planar structural view of a pixel circuit portion in Embodiment 1 of the present invention.

FIG. 2 is a sectional view taken along A-A′ line shown in FIG. 1.

FIG. 3 is a circuit constitutional view of an EL panel according to a current setting method.

FIG. 4 is a circuit constitutional view of an EL panel according to a voltage setting method.

FIG. 5 is a column control circuit constitutional viewer of an EL panel according to the current setting method.

FIG. 6 is a column control circuit constitutional view of an EL panel according to the voltage setting method.

FIG. 7 is a planar structural view of a pixel circuit portion in Embodiment 2 of the present invention.

FIG. 8 is a sectional view taken along a B-B line shown in FIG. 7.

FIG. 9 is a block diagram of a display apparatus utilizing Embodiment 1 or Embodiment 2.

FIG. 10 is a constitutional view of a pixel circuit of an EL panel according to the voltage setting method.

FIG. 11 is a constitutional view of a pixel circuit of an EL panel according to the current setting method.

FIG. 12 is a plan view showing a modified embodiment of an intersection portion.

### DETAILED DESCRIPTION OF THE PREFERRED EMBODIMENTS

Hereinbelow, embodiments of the present invention will be described more specifically with reference to the drawings.

### EMBODIMENT 1

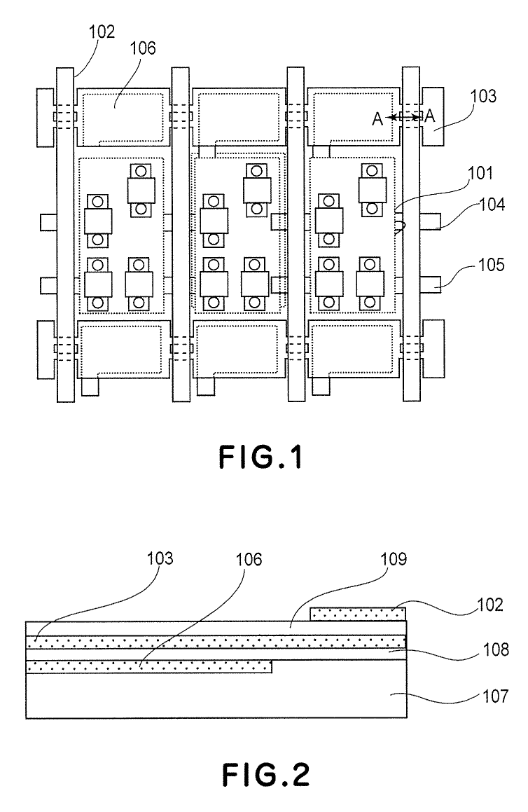

FIG. 1 is a planar structural view showing a part of a pixel circuit using a current setting method in Embodiment 1 of the present invention, wherein a plurality of data lines extending in a row direction in which current data are supplied and power lines for supplying electric power to respective pixel circuits are disposed. In FIG. 1, a constitution of each pixel circuit is identical to that shown in FIG. 11. FIG. 2 is a sectional view taken along an A-A line shown in FIG. 1.

Referring to FIG. 1, a reference numeral 101 represents a pixel circuit portion using the current setting method as shown in FIG. 11. A reference numeral 102 represents a data line, a reference numeral 103 represents a power line, and reference numerals 104 and 105 represent row control lines. As shown in FIG. 1, the data line 103 has such a structure that it has a line width at an intersection with the data line 102, smaller than that at a position other than the intersection. Based on the structure, a parasitic capacitance generated at the intersection between the power line 103 and the data line 102 is decreased, whereby it is possible to stabilize a writing operation of current data I (data) into a selected pixel. Particularly, it is possible to accurately write a minute current (black current) for displaying a black level. A narrower line width portion of the power line 103 is located at a central portion of the power line 103 in FIG. 1 but can also be located at an arbitrary position.

Incidentally, it is also possible to basically dispose the power line in parallel to the data line. However, as described later, it is desirable that the power line is disposed perpendicularly to the data line.

More specifically, the power line is required that it has a larger line width than other interconnecting lines so as to realize a low electric resistance in order to permit flow of the sum of current of driving current for driving an EL device constituting each pixel. As shown in FIGS. 1 and 2, in order to form a high-definition pixel in a constitutional layout, a capacitor C1 (as shown in FIG. 11) provided in each pixel circuit is created by disposing an electrode 106 so that it overlaps with the power line 103. Further, in the pixel circuit area (portion) 101 (corresponding to one pixel), four transistors are disposed. Here, when the power line is disposed in parallel with the data line, it is necessary to dispose the capacitor C1 and the four transistors so as to be arranged, between adjacent data lines, in a direction of arrangement of the data lines. For this reason, such an arrangement is disadvantageous for high-definition image formation. Thus, it is desirable that such a layout that the data line is extended in a direction perpendicular to the data line.

In FIG. 2, the structure includes a substrate 107 and insulating layers 108 and 109. The electrode 106 is formed in a polysilicon area, and wiring layers (electrode layers) are disposed in the order of the data line, the power line, and the capacitive electrode (one end) from above the structure. In FIG. 1, the power line portion at the intersection with the data line 102 is depicted in a narrowed shape so as to be in parallel to other power line portions located at positions other than the intersections but may also be appropriately modified in shape.

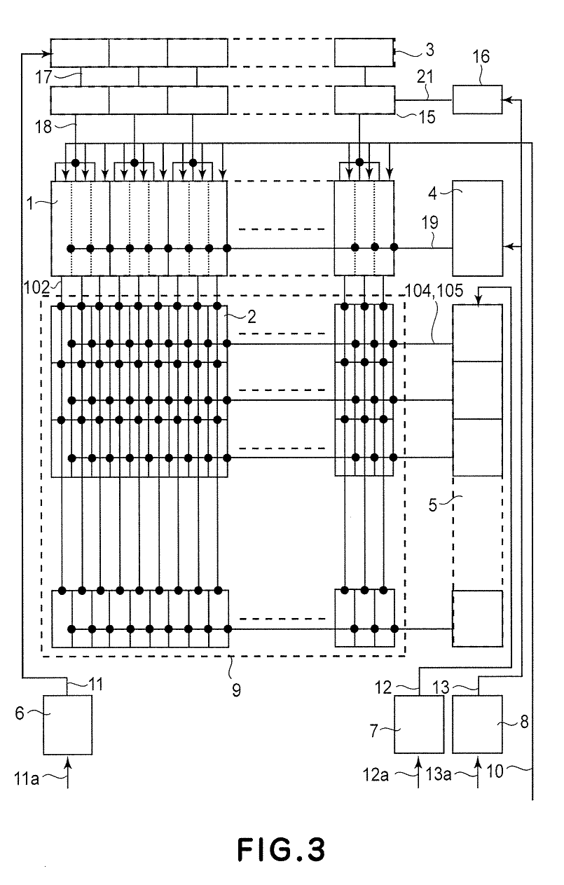

Next, a circuit constitution of an EL panel having the above described pixel circuits disposed two-dimensionally is shown in FIG. 3. An input image signal for red (R), green (G), and the blue (B) is inputted into column control circuits 1 which are provided in number three times the number of horizontal pixels of the EL panel. Thereafter, a horizontal control signal 11a is inputted into an input circuit 6 from which a horizontal control signal 11 is outputted and is inputted into a horizontal shift register 3.

An auxiliary column control signal 13a is inputted into an input circuit 8 and outputted therefrom as an auxiliary column control signal 13, which is then inputted into gate circuits 4 and 16. Horizontal sampling signals 17 outputted to output terminals corresponding to the respective columns of the horizontal shift register 3 are inputted into a gate circuit 15 into which a control signal outputted from the gate circuit 16. Horizontal sampling signals converted by the gate circuit 15 are inputted into a column control circuit 1. Into the column control circuit 1, a control signal 19 outputted from the gate circuit 4 is inputted. A vertical control signal 12a is inputted into an input circuit 7 and is outputted therefrom as a vertical control signal 12, which is inputted into a vertical shift resister 5 from which a scanning signal is inputted to row control lines 104 and 105.

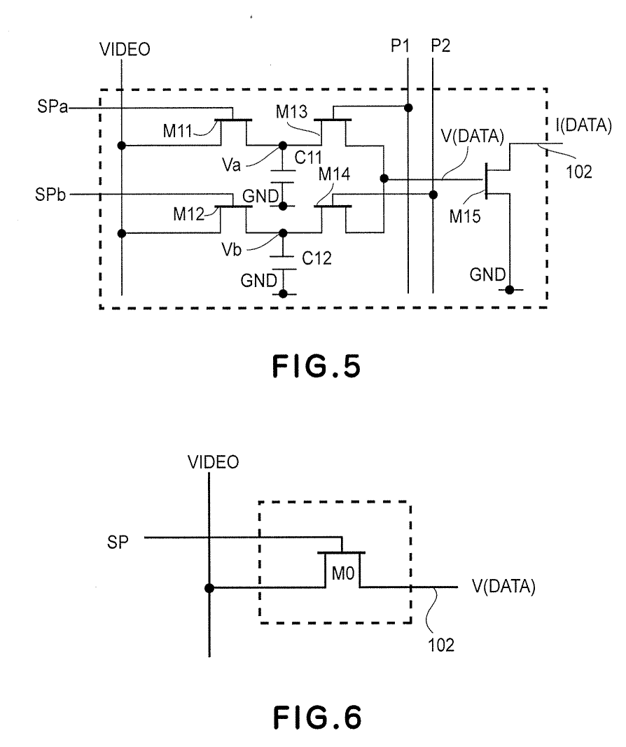

A data signal from the column control circuit 1 is inputted into each pixel circuit via the data line 102. An example of the column control circuit 1 is shown in FIG. 5. Referring to FIG. 5, an input image signal (Video) is inputted into sources of transistors M11 and M12, horizontal sampling signals SPa and SPb are inputted, respectively. A drain of the transistor M11 is connected with a source of a transistor M13 and one terminal of a capacitor C11 which is grounded (GND) at the other terminal. A gate of the transistor M13 is connected with a control signal line P1. A drain of the transistor M12 is connected with a source of a transistor M14 and one terminal of a capacitor C12 which is grounded (GND) at the other terminal. A gate of the transistor M14 is connected with a control signal line P2. Drains of the transistors M13 and M14 are connected with a gate of a transistor M15. A source of the transistor M15 is grounded (GND) . From a drain of the transistor M15, current data I (data) are outputted.

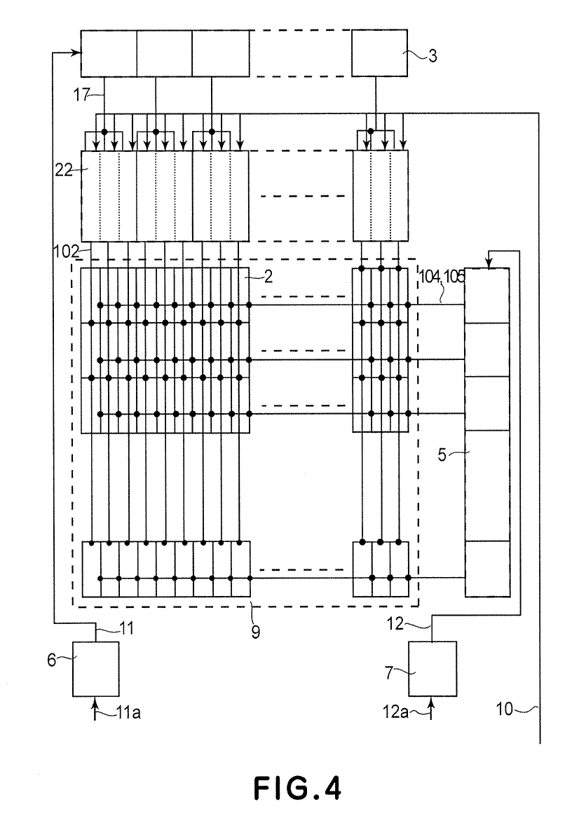

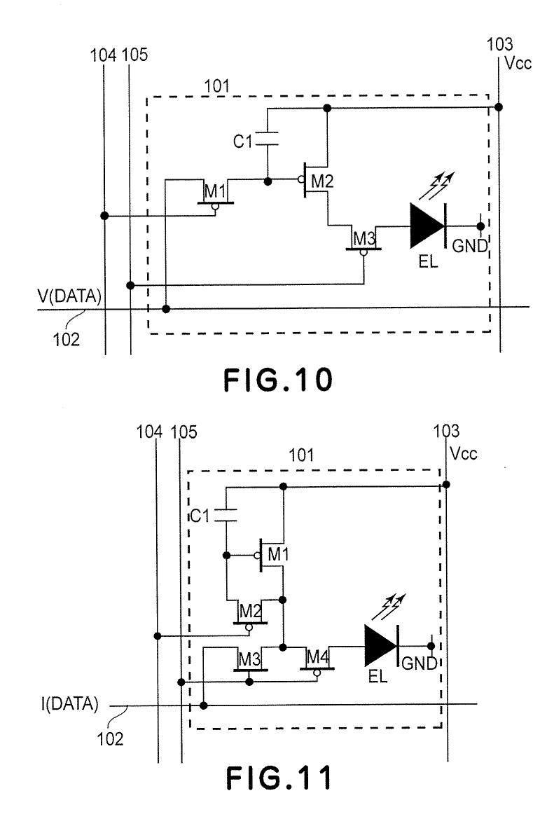

As described above, in the embodiment, the display panel including the pixel circuit using the current setting method is described. However, as described above, it is also possible to narrow the power line width at the intersection thereof with the data line in a display panel having a pixel circuit using the voltage setting method as shown in FIG. 10. Further, it is also possible to achieve a similar effect such that a writing operation of voltage data V(data) into a selected pixel is stabilized. FIG. 4 shows a circuit constitution of an EL panel including pixel circuits, using the voltage setting method, disposed two-dimensionally similarly as in those shown in FIG. 3. The circuit constitution is different from that shown in FIG. 3 in that the input circuit 8, the gate circuit 4, the gate circuit 15, and the gate circuit 16 are not provided and that the horizontal shift register 3 is connected with the column control circuit 22.

The column control circuit 22 is the circuit constitution shown in FIG. 4 is specifically shown in FIG. 6. As shown in FIG. 6, a horizontal sampling signal line SP is connected with a gate of a transistor M0, and an input image signal (Video) is inputted into a source of the transistor M0. Further, from an output of a drain of the transistor M0, voltage data V(data) of a column control signal 14 is outputted.

### EMBODIMENT 2

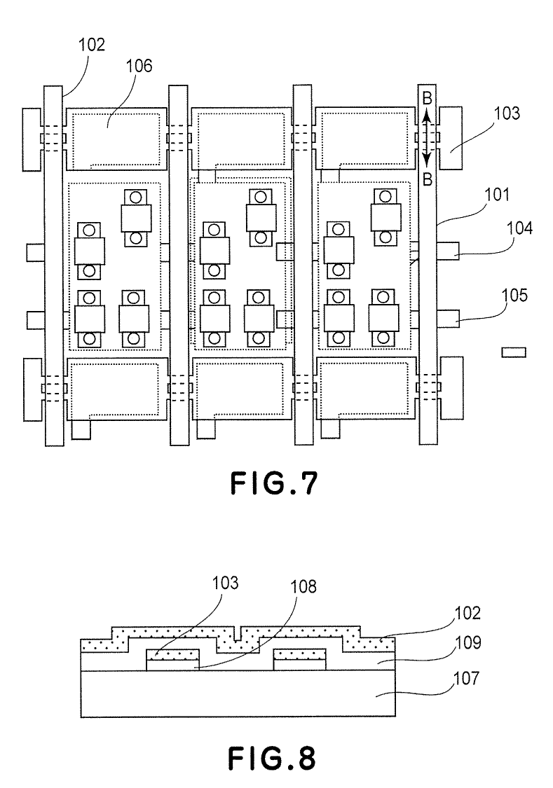

FIG. 7 is a planar structural view of an EL panel of Embodiment 2 at a pixel portion, and FIG. 8 is a sectional view taken along a B-B line shown in FIG. 7. Referring to these figures, a reference numeral 101 represents a pixel circuit portion, e.g., as shown in FIGS. 10 and 11. In FIG. 7, the planar structure includes a data line 102, a power line 103, and control lines 104 and 105. In FIG. 8, the structure includes a substrate 107 and insulating layers 108 and 109.

A difference of Embodiment 2 from Embodiment 1 is in that the data line 103 is branched into two portions at each intersection with the data line 102. When the power line with is decreased, an interconnecting line is liable to be cut due to overcurrent in some cases. In this embodiment, at the intersection where the power line with is decreased, the power line is branched into two portions, so that reliability of the power line is improved. Further, at the intersection between the power line and the data line, the data line has a line width smaller than that at a position other than the intersection, so that it is possible to achieve the same effect as in Embodiment 1. Incidentally, in this embodiment, the power line 103 is branched into two portions at the intersection with the data line 102 but may also be branched into three or more portions. In this case, it is also possible to achieve the same effect as in this embodiment.

Incidentally, in Embodiments 1 and 2, with respect to the pixel circuits shown in FIGS. 10 and 11, the type of conduction of the transistor M2 in FIG. 10 and the transistor M1 in FIG. 11 may also be changed to a reverse conduction-type. More specifically, the transistors M2 and M1 shown in FIGS. 10 and 11 are a pMOS transistor but may also be changed to an nMOS transistor. Other transistors are operated as a switching transistor, so that they basically have any conduction type. In the case of the nMOS transistor, an anode and a cathode of the EL device are reversed, so that Vcc is connected to the anode. As a result, the voltage is the power line is not Vcc but is GND.

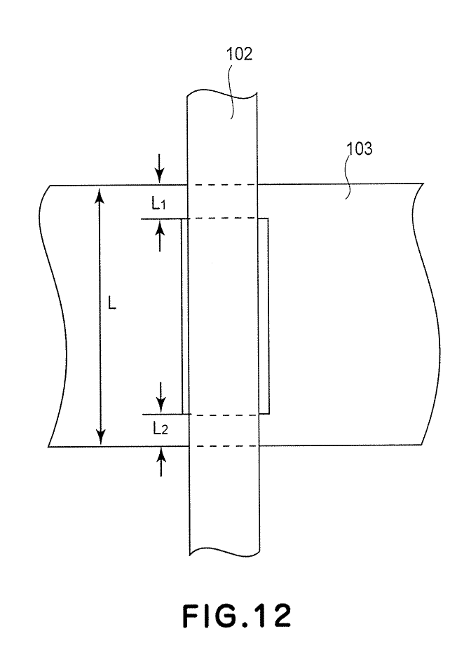

Incidentally, in the present invention, a manner of branching is not limited to that of the constitution in FIG. 7 but may also be such a branching manner that the sum of line widths (L1 and L2) of the plurality of branched portions is smaller than a line width (L) at a position other than the intersection, i.e., (L1+L2)<L. The constitution shown in FIG. 7 satisfies this relationship. It is also possible to branch the power line 103 into two portions located at both end portions thereof as shown in FIG. 12.

### EMBODIMENT 3

In this embodiment, an example in which the EL panel in Embodiment 1 or Embodiment 2 is used in electronic equipment will be described.

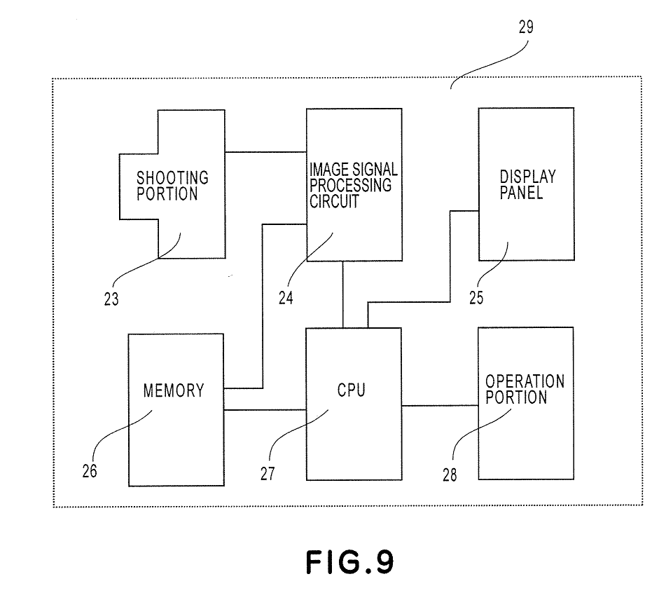

FIG. 9 is a block diagram of an example thereof of a digital still camera. Referring to FIG. 9, an entire system 29 includes an image shooting portion 23 for shooting a subject, an image signal processing circuit 24, a display panel 25, a memory 26, a CPU 27, and an operation portion 28. An image which is shot by the shooting portion 23 or stored in the memory 26 is signal-processed by the image signal processing circuit 24, and is viewable by the display panel 25. The CPU 27 controls the shooting portion 23, the memory 26, the image signal processing circuit 24, and the like based on an input from the operation portion, thus effecting shooting, recording, reproduction, or display depending on situation.

In the case where the EL panel in Embodiment 1 or Embodiment 2 described above is used as the display panel 25, it is possible to provide a high-quality display panel by suppressing the generation of parasitic capacitance of the power lines and the data lines to stabilize a writing operation of data into a pixel portion. Further, the display panel may also be utilized as a display portion of various electronic equipment such as a digital video camera, a PDA, and a mobile phone or as a display apparatus for a television set etc.

The present invention is not limited to the above described embodiments but may also be applicable to other wiring constitutions in which the data lines generate parasitic capacitance in combination with interconnecting lines similarly as in the case of the data lines. Further, the present invention is also applicable to another active matrix type display apparatus such as a liquid crystal display apparatus, in addition to the EL display apparatus illustrated in the above described embodiments. In the liquid crystal display apparatus, an auxiliary capacitor connected in parallel to a liquid crystal layer creates a capacitance capable of sufficiently holding a voltage for driving the liquid crystal material when a pixel selection switch is turned off. For this reason, the power lines are required that they have a line width larger than those of other lines to crease a capacitance capable of stably drive the liquid crystal material. In the present invention, also in the case of the liquid crystal display apparatus, the power line width at the intersection between the power line and the data line is made smaller than that at a position other than the intersection. Alternatively, the power line is branched into a plurality of portions at the intersection with the data line so that the sum of line widths of the branched portions is smaller than a line width thereof at a position other than the intersection.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 312786/2005 filed Oct. 27, 2005, which is hereby incorporated by reference.

What is claimed is:

1. An active matrix-type display apparatus, comprising:
a plurality of pixels, each comprising a display device and an active element, arranged two-dimensionally;
a plurality of data signal lines extending in one direction; and
a plurality of power lines extending in a direction perpendicular to the data signal lines;
wherein the power lines have a line width, at intersections of the data signal lines and the power lines, smaller than that at a position other than the intersections.

2. An apparatus according to claim 1, wherein at the intersections, each of the power line is branched into a plurality of power lines so that a sum of line widths of the branched power line power lines is smaller than a line width of the power lines at the position other than the intersections.

3. An active matrix-type display apparatus, comprising:
a plurality of pixels, each comprising a display device and an active element, arranged two-dimensionally;
a plurality of data signal lines extending in a direction; and
a plurality of power lines extending in a direction perpendicular to the data signal lines;
wherein each of the power lines is branched into a plurality of power lines at intersections of the data signal lines and the power lines, so that a sum of line widths of the branched power line power lines is smaller than a line width of the power lines at a position other than the intersections.

4. An apparatus according to claim 1, wherein the data signal lines are supplied with a current signal as a data signal.

5. An apparatus according to claim 1, wherein the data signal lines are supplied with a voltage signal as a data signal.

6. An apparatus according to claim 1, wherein the display device is an electroluminescence device.

7. A camera comprising:
an active matrix-type display apparatus according to claim 1;
an image shooting portion for shooting a subject of shooting; and
an image signal processing portion for processing a signal of image shot by the image shooting portion;
wherein the image signal processing portion processes an image signal so as to display an image by the active matrix-type display apparatus.
